(19) United States
(12) Patent Application Publication
(10) Pub. No.: US 2010/0067895 A1
(43) Pub. Date: Mar. 18, 2010

(54) Fastener For Fixing A Sliding Cover Of A Camera

(75) Inventors: Te-Hung Yin, Taipei Hsien (TW); Jui-Pin Lin, Taipei Hsien (TW); Yung-Yi Chen, Taipei Hsien (TW); Ming-Han Lin, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/210,478

(22) Filed: Sep. 15, 2008

(51) Int. Cl. G03B 17/00

(52) U.S. Cl. 396/448

(57) ABSTRACT

A fastener is adapted for fixing a sliding cover of a camera. The sliding cover is arranged slidably on the camera for selectively covering a lens of the camera. The fastener has a housing with a receiving cavity defined by a circular sidewall. An elastic component and a cover are received in the receiving cavity of the housing. One end of the cover is pressed against the elastic component, and the other end of the cover defines a resistive portion extending out of the receiving cavity for elastically and forcefully urging the sliding cover when the sliding cover is slid to cover the lens.

### BACKGROUND OF THE INVENTION

1. Field of the Invention

This present invention relates to a fixing component, and more specifically to a fastener adapted for fixing a sliding cover of a camera in place.

2. The Related Art

Conventionally, a camera has a lens and a sliding cover which covers the lens when the camera is not in use. The camera has two sliding grooves arranged symmetrically near the lens. The cover has two sliding arms. The sliding arms are arranged to engage elastically and slid in the corresponding sliding grooves. Thus the sliding cover can cover above the lens when the camera is not in use for preventing the lens from scraping and dirtying, and also be pushed to slide away from the lens when the camera is in use. However, such structure is not good enough; for example, the sliding arm may become loose because of frequent use, thus resulting in unstable fixation of the sliding cover. Thus the sliding cover is susceptible to sliding away from the lens accidentally, thus causing damage to the delicate lens.

### SUMMARY OF THE INVENTION

An object of the invention is to provide a fastener adapted for fixing a sliding cover of a camera. The sliding cover is arranged slidably on the camera for selectively covering a lens of the camera. The fastener has a housing with a receiving cavity defined by a circular sidewall. An elastic component and a cover are received in the receiving cavity of the housing. One end of the cover is pressed against the elastic component, and the other end of the cover defines a resistive portion extending out of the receiving cavity for elastically and forcefully urging the sliding cover when the sliding cover is slid to cover the lens.

As above description, the cover of the fastener is supported by the elastic component so that the resistive portion extends out of the receiving cavity for abutting the sliding cover. The resistive portion and the sliding cover are against each other under resilience action of the elastic component so as to fix the sliding cover. Such structure is capable of fixing the sliding cover in frequent use for a long time and preserving the lens of the camera from damage.

### BRIEF DESCRIPTION OF THE DRAWINGS

The invention, together with its objects and the advantages thereof may be best understood by reference to the following description taken in conjunction with the accompanying drawings, in which:

FIG. 1 is a perspective view of a first embodiment of a fastener for fixing a sliding cover of a camera in place in accordance with the present invention;

FIG. 2 is an exploded view of the fastener in the first embodiment;

FIG. 3 is a cross-sectional view taken along line III-III of FIG. 1;

FIG. 4 is a perspective view of a second embodiment of a fastener for fixing a sliding cover of a camera in place;

FIG. 5 is an exploded view of the fastener in the second embodiment; and

FIG. 6 is a schematic view showing the fastener of the first embodiment assembled in a camera with a sliding cover.

### DETAILED DESCRIPTION OF THE PREFERRED EMBODIMENTS

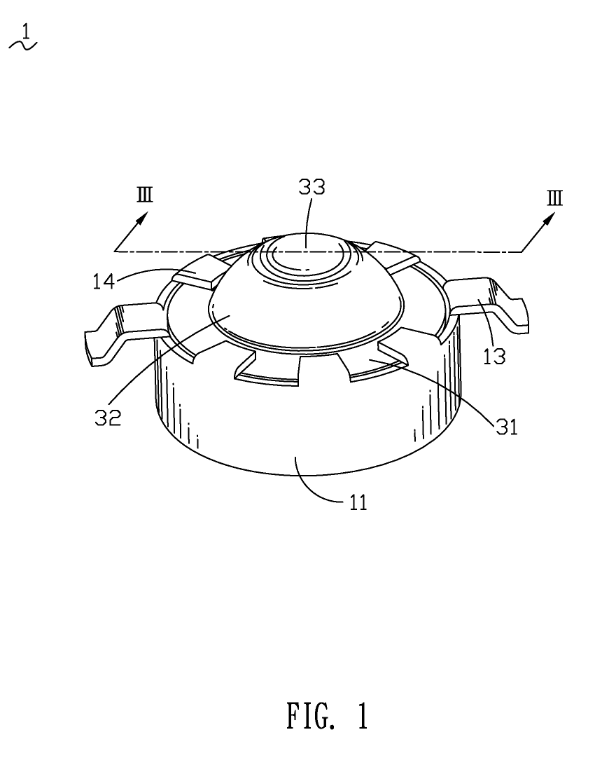

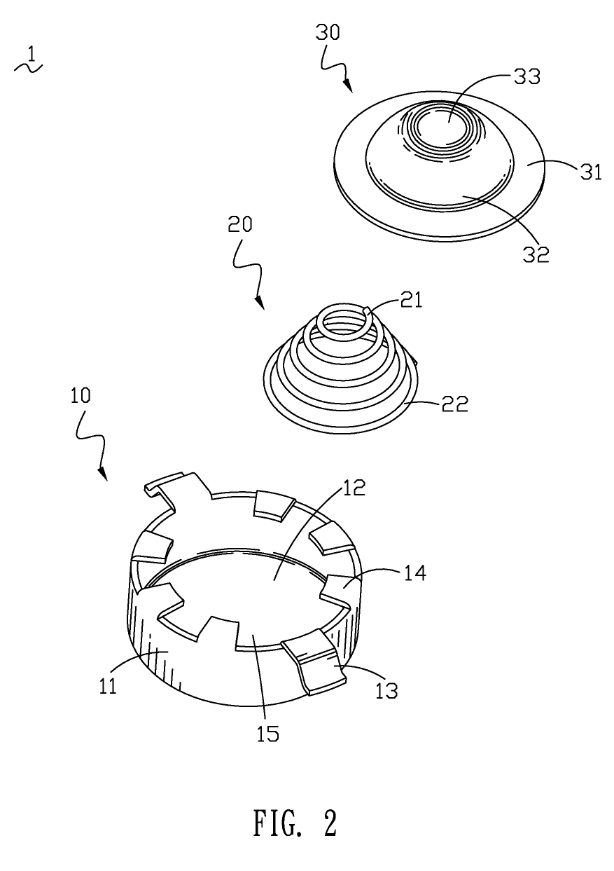

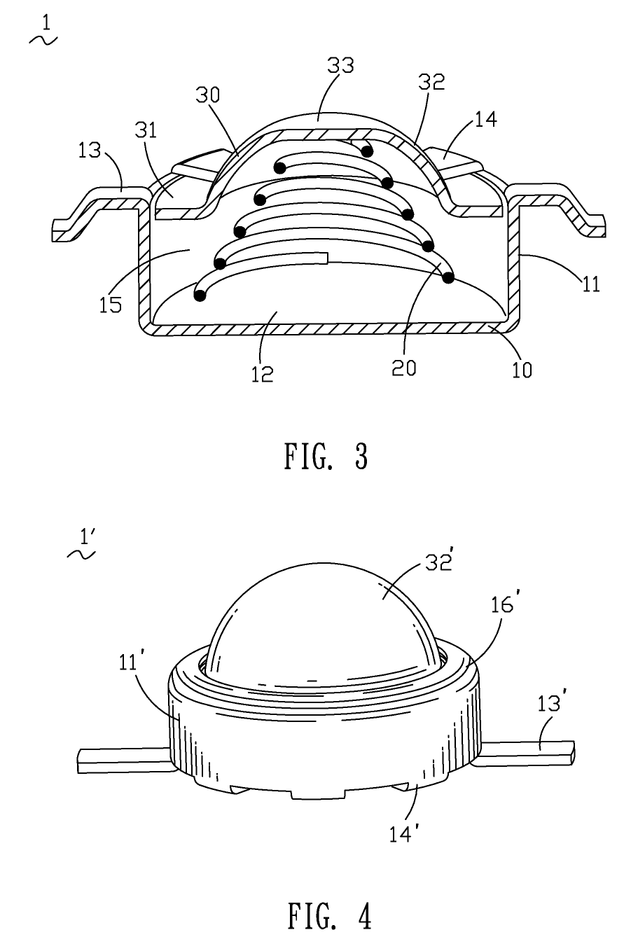

Referring to FIGS. 1-3, a fastener 1 for fixing a sliding cover of a camera in place according to a first embodiment of the present invention is disclosed. The fastener 1 in the first embodiment comprises a housing 10, an elastic component 20 and a cover 30. The elastic component 20 and the cover 30 are received in the housing 10, and the elastic component 20 is located between the housing 10 and the cover 30.

The housing 10 has a receiving cavity 15 with a bottom 12 defined therein and a circumferential sidewall 1 defining the receiving cavity 15 therein. The receiving cavity 15 is used to receive the elastic component 20 and the cover 30. A top of the sidewall 1 diametrically symmetrically bends outwards to form two fixing portions 13 for fixing the fastener 1 to the camera, and extends to form a plurality of buckling pieces 14. The buckling pieces 14 will be bent inwards after the cover 30 is placed in the receiving cavity 15 for preventing the cover 30 from breaking away from the housing 10.

The elastic component 20 is a spring in this embodiment. The elastic component 20 has a first end 21 and a second end 22 opposite to the first end 21. In this embodiment, the elastic component 20 may be of a conical shape, that is, the elastic component 20 tapers from the second end 22 to the first end 21. The second end 22 of the elastic component 20 is located on the bottom 12 of the receiving cavity 15 and may be forcefully pressed against the bottom 12 when the elastic component 20 is compressed for example by a user.

The cover 30 has a flanged portion 31. The flanged portion 31 is a ring shape. A resistive portion 32 tapers upwards from an inner edge of the flanged portion 31 to show a substantial dome shape. It should be noted that the resistive portion 32 may further have a contact portion 33 at a top thereof for conforming to different demands and it should not be construed as limiting. The contact portion 33 is flat-shaped for contacting the sliding cover 7 steadily. Before the elastic component 20 and the cover 30 are received in the housing 10, the buckling pieces 14 spread outwards or are in same plane as the sidewall 11. After the elastic component 20 and the cover 30 are received in the receiving cavity 15, the first end 21 of the elastic component 20 resists a bottom surface of the cover 30 upwardly, and then the buckling pieces 14 are pressed inwards to button the flanged portion 31. Thus the fastener 1 is assembled.

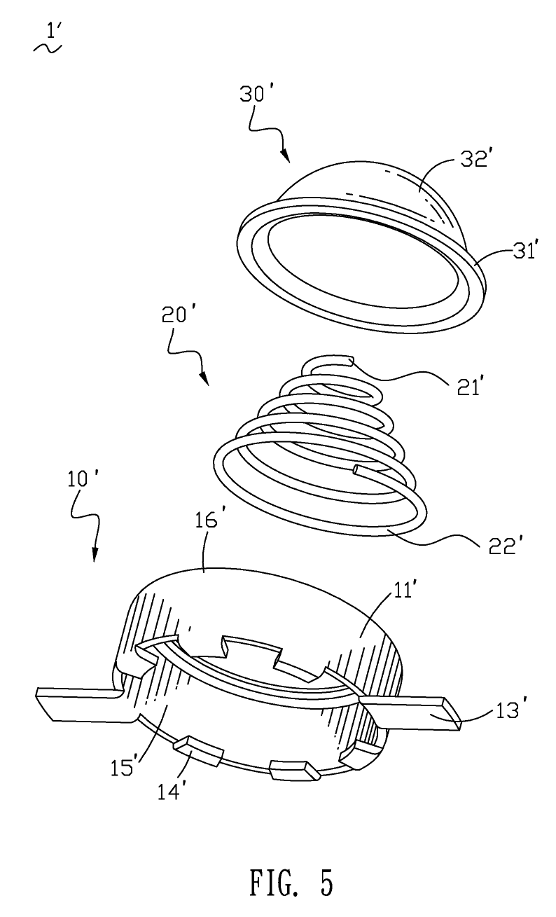

Please refer to FIGS. 4 and 5, the fastener 1′ in the second embodiment comprises a housing 10′, an elastic component 20′ and a cover 30′. The difference between the fastener 1 in the first embodiment and the fastener 1′ in the second embodiment is the shape of the housing 10′. In the second embodiment, the housing 10′ defines a circumferential sidewall 11′. One edge of the sidewall 11′ extends inwards a certain distance to form a restraining portion 16′, and the other edge of the sidewall 11′ has two fixing portions 13′ and a plurality of buckling pieces 14′ similar to the fixing portions 13 and the buckling pieces 14 of the first embodiment. The cover 30′ is placed into a receiving cavity 15′ defined by the sidewall 11′. The elastic component 20′ is received in the receiving cavity 15′ with the first end 21′ being pressed against a bottom surface of the cover 30′, and then the buckling pieces 14′ are pressed inwards to button the second end 22′. The cover 30′ is resisted upwardly by the first end 21′ to extend out of the receiving cavity 15′, and the restraining portion 16′ buttons the flanged portion 31′ of the cover 30 so as to block the cover 30′. Thus the cover 30′ is fixed to the housing 10′.

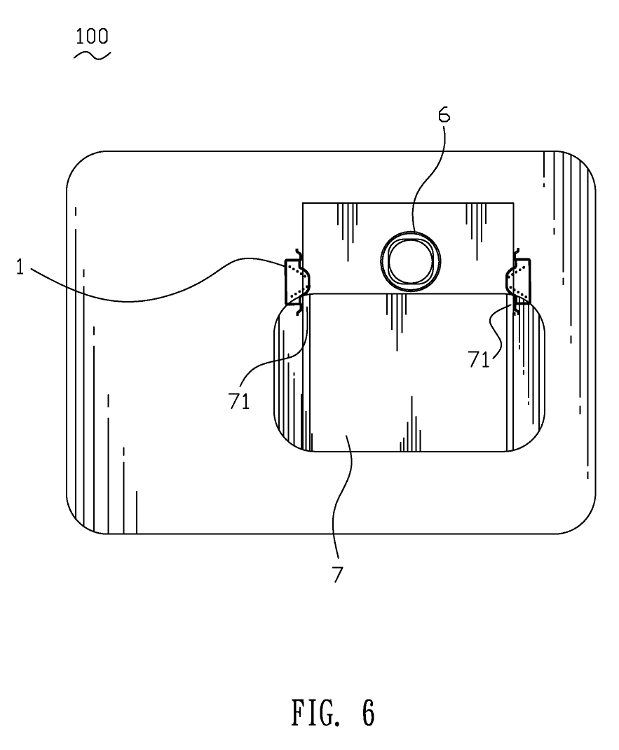

FIG. 6 is schematic view showing the fastener 1 in the first embodiment assembled in a camera 100 with a sliding cover 7 for fixing the sliding cover 7 to protect a lens 6 of the camera 100. Two fasteners 1 are arranged in the camera 100 along two sides of a cavity with the lens 6 located therein. The cover 30 of the fastener 1 partly extends in the cavity. When the sliding cover 7 is slid upwardly to cover the lens 6, the contact portions 33 of the cover 30 are respectively pressed back by two sliding walls 71 of the sliding cover 7. The cover 30 is pressed back so as to compress the elastic component 20, which makes the contact portion 33 abut against the sliding wall 71 firmly because of resilience action of the elastic component 20.

As described above, the cover 30 of the fastener 1 is supported by the elastic component 20 so that the contact portion 33 extends out of the receiving cavity 15 for abutting the sliding wall 71. The contact portion 33 and the sliding wall 71 are against each other under resilience action of the elastic component 20 so as to fix the sliding cover 7 steadily. Such structure is capable of fixing the sliding cover 7 in frequent use for a long time and preserving the lens 6 of the camera from damage.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A fastener adapted for releasably fixing a sliding cover of a camera over a lens of the camera, the sliding cover being arranged slidably on the camera for selectively covering the lens of the camera, the fastener comprising:
a housing having a circular sidewall and a receiving cavity defined by the circular sidewall;
an elastic component received in the receiving cavity of the housing; and
a cover received in the receiving cavity, one end of the cover contacting the elastic component, the other end of the cover defining a resistive portion which extends out of the receiving cavity for elastically and forcefully urging the sliding cover when the sliding cover is slid to cover the lens.

2. The fastener as set forth in claim 1, wherein a top of the sidewall forms a plurality of buckling pieces which are bent inwards after the cover is placed in the receiving cavity for preventing the cover breaking away from the housing.

3. The fastener as set forth in claim 1, wherein the sidewall bends outwards to form two fixing portions for fixing the fastener to the camera.

4. The fastener as set forth in claim 1, wherein one edge of the sidewall bends inwards to form a restraining portion, the restraining portion buckles the cover for preventing the cover breaking away from the housing, and the other edge of the sidewall forms a plurality of buckling pieces which are bended inwards after the elastic component is placed in the receiving cavity for blocking the elastic component.

5. The fastener as set forth in claim 1, wherein the elastic component is a compressible conical spring.

6. The fastener as set forth in claim 1, wherein the resistive portion shows a substantial dome shape.
